(19) United States
(12) Patent Application Publication
(10) Pub. No.: US 2023/0248484 A1
(43) Pub. Date: Aug. 10, 2023

(54) MULTI-IMPLANT DRIVER DEVICE

(71) Applicant: Boris Kaylakov, Rego Park, NY (US)

(72) Inventor: Boris Kaylakov, Rego Park, NY (US)

(21) Appl. No.: 18/105,112

(22) Filed: Feb. 2, 2023

Related U.S. Application Data
(60) Provisional application No. 63/307,102, filed on Feb. 5, 2022.

(51) Int. Cl. A61C 8/00

(52) U.S. Cl. CPC A61C 8/0089; A61C 8/0068

(57) ABSTRACT

In an embodiment, a multi-implant driver device for dental implant prosthesis is provided. The device comprises a housing body, four dental implant drivers, and a front head for guiding the implant drivers. Said front head is positioned at a front end of the housing body. A pressing piece is positioned in a chute on the said housing body and simultaneously connected with a tail end of a spring. A fixed seat for supporting and fixing a refill and the spring are arranged in the housing body. Said drivers pass through the spring on the fixed seat and are assembled in front head. A top plug with a gap is arranged at the tail end of the said housing body. When the driver is changed, the gap of the top plug is aligned with a central line of the chute of the said housing body by rotating the top plug.

### CROSS REFERENCE TO RELATED APPLICATIONS

The present non-provisional patent application is related to U.S. Provisional Pat. Application No. 63/307,102 filed Feb. 5, 2022, the contents of which are incorporated herein in their entirety.

### FIELD OF THE DISCLOSURE

The present disclosure is in the field of devices for dental implant prosthesis. More particularly, the present disclosure provides a multiple implant driver device that simultaneously handles multiple implant drivers and that further rapidly changes dental implant driver.

### BACKGROUND

An implant is a titanium screw that is placed inside the patient’s upper or lower jawbone that essentially replaces a root of the tooth. Dental implantology is a fast-growing field of interest for many patients. Many patients prefer dental implants over dentures, especially younger patients. Dental implants may be ideal for patients when either a tooth is missing or a patient needs to extract existing tooth, because it is non-restorable.

In previous implementations, four to six months after implant placement, a cover screw is replaced with a healing abutment on top of the healed implant. Two weeks later, an impression is taken. The implant crown is then either cemented on top of implant final abutment or screwed on top of implant interface depending on the provider’s recommendation or patient preference.

For example, implant crowns are usually cemented in front areas because the patient’s esthetics are important since no screw is visible with cemented crowns. On the other hand, for posterior missing teeth or back areas providers typically recommend a screw-retained implant crown.

It is noteworthy that these screws, whether cover screws, healing abutment screws, or permanent abutment screws as well as screwdrivers that fit these screws are different in shape and sometimes size depending on the provider of the original implant.

There are many implant providers, each with unique implant system. Each provider has a unique set of keys or screwdrivers that usually fit their implant screw type, whether the screw type is a cover screw or a permanent abutment screw.

Because of the uniqueness of each implant brand, many dental professionals have the cumbersome task of restoring implants with proper prosthesis. Each implant brand has a unique screwdriver set that fits the specific abutment screw from the implant provider. Dental professionals are forced to deal with multiple drivers, a challenge that can result in longer procedural times and cluster.

### BRIEF DESCRIPTION OF THE DRAWINGS

FIG. 1 is an exploded perspective view of an implant dental restoration system according to an embodiment of the present disclosure.

FIG. 2 is a view of a fully assembled dental implant driver device of an implant dental restoration system according to an embodiment of the present disclosure.

### DETAILED DESCRIPTION

The present disclosure is directed to problems associated with multiple dental drivers and longer procedure time and cluster. Systems and methods described herein provide a multi-color pressing driver device capable of quickly switching dental implant drivers.

The implant device comprises a housing body, four dental implant drivers, and a front head for guiding the implant drivers. The front head is positioned at a front end of the housing body. A pressing piece is positioned in a chute on the housing and is simultaneously connected with the tail end of a spring. A fixed seat for supporting and fixing the refill and the spring is arranged in the housing body. The driver passes through the spring on the fixed seat and is assembled in the front head.

A top plug is arranged at the top of the housing body. The periphery of a top plug is provided with more than one gap. Accordingly, the multi-color pressing device is capable of quickly changing the implant drivers. The top plug with the gap is arranged at the tail end of the housing body. When the driver is changed, the gap of the top plug is aligned with the central line of the chute of the housing body by rotating the top plug. The driver and the pressing piece can be taken out together. A new driver and new pressing piece are changed easily. The fixed seat is arranged at the middle or rear part of the housing body. The clearance fit between the spring and the other drivers is stable. The replacement drivers are assembled and readily for use.

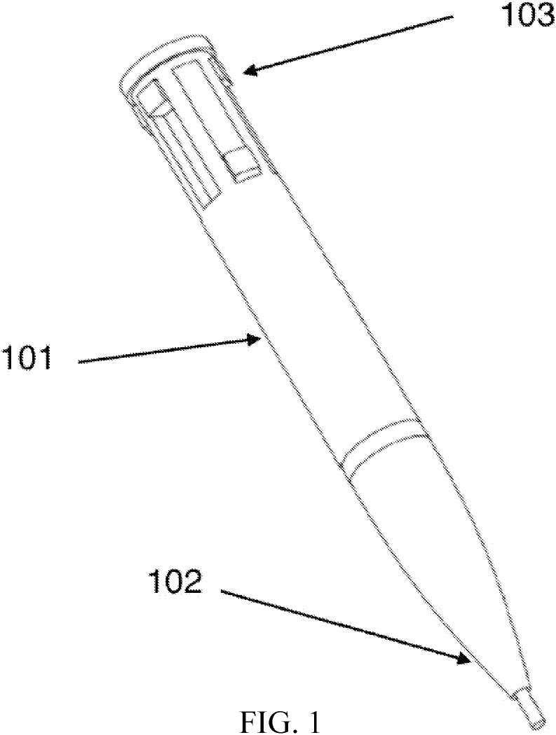

FIG. 1 is an exploded perspective view of the system. The implant driver device comprises a housing body (101), four dental implant drivers, and a front head (102) for guiding the implant drivers. The front head is positioned at the front end of the housing body. A pressing piece (103) is positioned in a chute on the housing and is simultaneously connected with the tail end of a spring. A fixed seat for supporting and fixing the refill and the spring is arranged in the housing body. The driver passes through the spring on the fixed seat and is assembled in the front head.

The device may readily be disassembled after use for sterilization. The system further comprises a multi-colored shaft attached to a main screw-in mechanism at a collar of the device. Easily unscrewed, all four screwdrivers may be exposed for easy sterilization. In the event a screw jams or detaches from the spring system, easy unwinding of tip may be accomplished. The screwdriver can be placed back on. Color-matching systems are of value. The correct driver goes to the proper location on the device. After sterilization, the device may readily be reassembled by screwing in tip into main spring system at the base of collar.

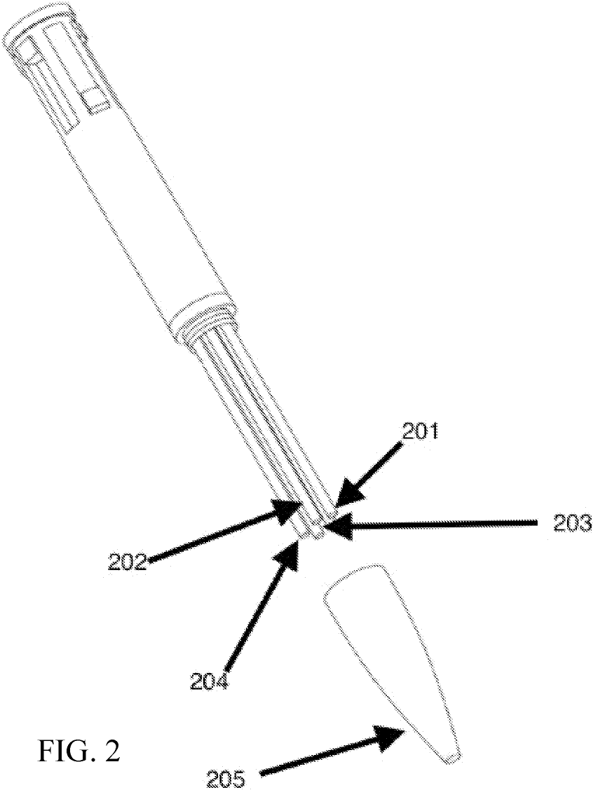

FIG. 2 is a partially disassembled view of the system. The invention comprises four different drivers ranging (201) 1.2 mm Hex (works with Nobel biocare, 31, Keystone, Megagen, Hiossen, Dentium), (202) 1.25 mm Hex (Zimmer, Astra, Biohorizons, Intr-Lock, MIS, SteriOss, Sybron, Implant direct, PerioSeal), (203) ITI/SCS (works with ITI driver for Straumann SCS), and (204) Star/UniGrip (works with star driver for Nobel Biocare Active and Unigrip screw, Neoss).

Insert screwdrivers are color coded based on implant brand for easy retrieval and visibility. A front head (205) is for guiding the implant drivers. Since this is a four-in-one type of device, or because of its more compact size, it may be convenient to have it on-the-go. It takes less space in dental cabinets and sterilization area. Moreover, besides being useful for many dentists, due to compact size and ease of retrieval of needed driver, this device can be very useful for lab technicians who use dental stone to make crowns or other prosthesis from dental impressions.

In an embodiment, a multi-implant driver device for dental implant prosthesis is provided. The device comprises a housing body, four dental implant drivers, and a front head for guiding the implant drivers. Said front head is positioned at a front end of the housing body. A pressing piece is positioned in a chute on the said housing body and simultaneously connected with a tail end of a spring. A fixed seat for supporting and fixing a refill and the spring are arranged in the housing body. Said drivers pass through the spring on the fixed seat and are assembled in the said front head. A top plug with a gap is arranged at the tail end of the said housing body. When the driver is changed, the gap of the top plug is aligned with a central line of the chute of the said housing body by rotating the top plug. Said driver and the pressing piece can be taken out together.

In the embodiment, a fixed seat is arranged at a middle part or a rear part of the said housing body. The arrangement promotes stable clearance fit between the spring and the other said drivers and promotes the replace drivers being assembled and readily for use. The device is easily disassembled after use for sterilization by unscrewing the tip from the main spring system at the base of collar. The device is reassembled by screwing in tip into main spring system at a base of collar.

In the embodiment, said four dental implant drivers are different in shape and size. Said four dental implant drivers are the following: 1.2 mm Hex (works with Nobel biocare, 31, Keystone, Megagen, Hiossen, Dentium), 1.25 mm Hex (Zimmer, Astra, Biohorizons, Intr-Lock, MIS, SteriOss, Sybron, Implant direct, PerioSeal), ITI/SCS (works with ITI driver for Straumann SCS), Star/UniGrip (works with star driver for Nobel Biocare Active and Unigrip screw, Neoss). The system promotes switching dental implant drivers by the press of a button. The system simultaneously handles multiple implant drivers. The system reduces procedural time and lowers cluster. Screwdrivers are exposable for sterilization and after sterilization, the device is reassembled by screwing in tip into main spring system at a base of collar. In an event a screw jams or detaches from the spring system, unwinding of tip enables the screwdriver to be placed back on. The device further comprises a color-matching system promoting correct placement of driver on the device.

What is claimed is:

1. A multi-implant driver device for dental implant prosthesis comprising:
a housing body,
four dental implant drivers, and
a front head for guiding the implant drivers.

2. The multi-implant driver device as in claim 1, wherein said front head is positioned at a front end of the housing body.

3. The multi-implant driver device as in claim 1, wherein a pressing piece is positioned in a chute on the said housing body and simultaneously connected with a tail end of a spring.

4. The multi-implant driver device as in claim 1, wherein a fixed seat for supporting and fixing a refill and the spring are arranged in the housing body.

5. The multi-implant driver device as in claim 1, wherein the said drivers pass through the spring on the fixed seat and are assembled in the said front head.

6. The multi-implant driver device as in claim 1, wherein a top plug with a gap is arranged at the tail end of the said housing body.

7. The multi-implant driver device as in claim 1, wherein when the driver is changed, the gap of the top plug is aligned with a central line of the chute of the said housing body by rotating the top plug.

8. The multi-implant driver device as in claim 1, wherein said driver and the pressing piece can be taken out together.

9. The multi-implant driver device as in claim 1, wherein a fixed seat is arranged at a middle part or a rear part of the said housing body.

10. The multi-implant driver device as in claim 9, wherein the arrangement promotes stable clearance fit between the spring and the other said drivers and promotes the replace drivers being assembled and readily for use.

11. The multi-implant driver device as in claim 1, wherein the device is readily disassembled after use for sterilization by unscrewing the tip from the main spring system at the base of collar.

12. The multi-implant driver device as in claim 1, wherein the device is reassembled by screwing in tip into main spring system at a base of collar.

13. The multi-implant driver device as in claim 1, wherein said four dental implant drivers are different in shape and size.

14. The multi-implant driver device as in claim 1, wherein said four dental implant drivers are the following: 1.2 mm Hex (works with Nobel biocare, 3I, Keystone, Megagen, Hiossen, Dentium), 1.25 mm Hex (Zimmer, Astra, Biohorizons, Intr-Lock, MIS, SteriOss, Sybron, Implant direct, PerioSeal), ITI/SCS (works with ITI driver for Straumann SCS), Star/UniGrip (works with star driver for Nobel Biocare Active and Unigrip screw, Neoss).

15. The multi-implant driver device as in claim 1, wherein the system promotes switching dental implant drivers by the press of a button.

16. The multi-implant driver device as in claim 1, wherein the system simultaneously handles multiple implant drivers.

17. The multi-implant driver device as in claim 1, wherein the system reduces procedural time and lowers cluster.

18. The multi-implant driver device as in claim 1, wherein screwdrivers are exposable for sterilization and after sterilization, the device is reassembled by screwing in tip into main spring system at a base of collar.

19. The multi-implant driver device as in claim 1, wherein in an event a screw jams or detaches from the spring system, unwinding of tip enables the screwdriver to be placed back on.

20. The multi-implant driver device as in claim 1, wherein the device further comprises a color-matching system promoting correct placement of driver on the device.
